(19) United States
(12) Patent Application Publication
(10) Pub. No.: US 2024/0349753 A1
(43) Pub. Date: Oct. 24, 2024

(54) PLANT BASED MEAT AND FISH ANALOG PRODUCTS

(71) Applicant: SOCIETE DES PRODUITS NESTLE S.A., Vevey (CH)

(72) Inventors: OLIVIER BRETON, Rueyres (CH); GUILHERME DE OLIVEIRA REIS, Lausanne (CH); LAURA HERZ, Stuttgart (DE); ANTHONY LIMA, Les Hopitaux Neufs (FR); CINDY PELLOUX, Champanges (FR); PATRICK PIBAROT, Taponnat-Fleurignac (FR); DELPHINE TISSOT-FAVRE, Jongny (CH); YU-JIE WANG, Beijing (CN); HANNES WENZEL, Lutry (CH); ROMAIN DAVAILLE, Vers L Eglise (CH); RICHARD PITTMANN, Clarens (CH)

(21) Appl. No.: 18/575,094

(22) PCT Filed: Jun. 30, 2022
(86) PCT No.: PCT/EP2022/068170

§ 371 Date: Dec. 28, 2023

(30) Foreign Application Priority Data
Jun. 30, 2021 (EP) 21182989.0

(51) Int. Cl. A23J 3/22; A23J 3/16; A23J 3/18; A23J 3/26; A23P 30/20

(52) U.S. Cl. CPC A23J 3/227; A23J 3/16; A23J 3/18; A23J 3/26; A23P 30/20

(57) ABSTRACT

The invention relates to a plant based meat or fish analogue product, said product comprising a plant protein based extrudate comprising at least two different plant proteins, wherein said plant protein based extrudate comprises fibres which are aligned in substantially the same direction, wherein the plant protein based extrudate is present as a single extruded slab or as a layer of two or more extruded slabs.

Recent years have seen a strong consumer trend towards plant based versions of meat based products. Most are made with texturized vegetable protein which involve grinding of extrudates into small pieces and gluing together with binder. In general, current products on the market have a texture and mouthfeel which is significantly different from meat products.

Additionally, products on the market typically have a long list of ingredients including thickener (xanthan gum), binder (methyl cellulose, maltodextrin), and preservatives. Such ingredients are not well perceived by consumers.

There is a clear need to provide plant based meat analogs which have an improved real meat texture and a short, clean label ingredient list.

### SUMMARY OF THE INVENTION

The invention relates to meat and fish analogues and methods of producing thereof wherein the extrudates are produced by wet extrusion of plant proteins with a short die, preferably a short conic die, more preferably with a short conic die.

The short conic die can have different geometries. The preferred geometry is a conic coat hanger die geometry.

The extrudates can be produced as continuous or semi-continuous slabs which are cut or stamped into pieces, preferably of defined size or shape.

The extrudates pieces can be either used as a unique piece or assembled into multilayer structures.

During assembly, a binder mixture is typically applied in between the layered pieces, which are then cooked at an appropriate temperature to set the binder and ensure good cohesiveness of the pieces.

A plant-based fat analogue can be also applied in between the layers to provide a fat marbling appearance of the meat and fish analogues, thereby improving the sensory profile.

The binder or fat analogue mixture can also comprise flavor solutions to improve the sensory profile and be closer to the targeted real meat flavor and taste.

By adjusting the texture, the color and the flavors this method allows to prepare a variety of different meat and fish analogues which can mimic beef, for example steak or roast; fish, for example fish fillet; pork; veal; lamb; cold cut, for example ham; and poultry; and other types of real meat foodstuff.

The texture can be adjusted using the same plant protein blend by fine tuning the extrusion temperature, extrusion throughput and dough moisture. Base note flavour or reactive flavour precursors can be added to the dough of the extrusion to adjust the taste and flavor depending on the targeted meat or fish analogues. Natural colour can also be used during the extrusion to adjust the extrudate colour.

The top note flavour can be added to the binder and/or fat analogue to adjust the final sensory profile after cooking and cooling.

A coating solution or a marinade can be used to improve the final quality of the assembled meat and fish analogues or to produce roasting of the meat and fish analogues pieces during final cooking before consumption in a pan, a grill pan, a oven or a BBQ.

### EMBODIMENTS OF THE INVENTION

The invention relates in general to plant based meat or fish analog products.

More specifically, the invention relates to plant based meat or fish analogue products comprising plant protein based extrudate.

More specifically, the plant based meat or fish analogue product comprises a plant protein based extrudate comprising at least two different plant proteins.

More specifically, the plant based meat analog product comprises a plant protein based extrudate comprising at least two different plant proteins, wherein said plant protein based extrudate comprises fibres which are aligned in substantially the same direction. Preferably, greater than 50% of the fibres are aligned in substantially the same direction. Preferably the fibres are bundled into bundles having a length of more than one millimeter and a thickness of between 3 to 500 micro meters. Preferably, the plant protein based extrudate is obtained using a coat hanger die, preferably, a 3-dimensional or conical coat hanger die, most preferably a short 3-dimensional coat hanger die.

More specifically, the plant based meat and fish analogue product comprises a plant protein based extrudate comprising at least two different plant proteins and a breaded coating surrounding the plant protein based extrudate.

More specifically, the plant based meat and fish analogues product is selected from (i) beef, for example steak or roast; (ii) fish, for example fish fillet; (iii) pork; (iv) veal; (v) lamb; (vi) cold cut, for example ham; and (vi) poultry, for example chicken, turkey. The meat analogue product may be a duck analogue product.

More specifically, the plant based meat or fish analogue product is the plant-based analog of a beef, for example steak or roast; or fish.

In one embodiment, the plant protein extrudate is present as a single extruded slab. In one embodiment, the plant protein extrudate is present as a layer of two or more extruded slabs.

Typically, he single extruded slab or layer of two or more extruded slabs have a thickness between 3 to 20 mm, or between 3 to 30 mm. For example, a layer of three extruded slabs may have a thickness of about 16 mm, or a layer of two extrudate slabs may have a thickness of about 10 mm. The single extruded slab or each slab in the layer of two or more extruded slabs may have a thickness between 1 to 10 mm, preferably between 3 to 6 mm.

In one embodiment, the ratio of nominal maximal force values required to cut the product perpendicular to the fibre direction compared to parallel or along the fibre direction is greater than 1.55, preferably greater than 2.

In one embodiment, the product has a sensory fibrous attribute score greater than 2.5. In one embodiment, the product has a compact score of less than 1.2. In one embodiment, the product has a chewy score of more than 2.3.

In one embodiment, a binding agent is present between the layer of two or more extruded slabs.

In one embodiment, a connective tissue analogue and/or fat analogue is present between the layer of two or more extruded slabs.

In one embodiment, the product comprises (i) between 10 to 40 wt % connective tissue analogue and/or fat analogue, preferably between 20 to 30 wt % connective tissue analogue and/or fat analogue; and (ii) between 60 to 90 wt % extrudate slabs, preferably between 70 to 80 wt % extrudate slabs.

In one embodiment, one of the at least two different plant proteins is wheat gluten. In one embodiment, one of the at least two different plant proteins is a pea protein, preferably a pea protein isolate. Preferably the wt % ratio of wheat gluten to pea protein is 30:70. In one embodiment, the at least two different plants are wheat gluten and pea protein, preferably pea protein isolate, or soy protein, preferably soy protein concentrate. In one embodiment, the plant protein based extrudate slabs comprise 5 to 15 wt % wheat gluten. In one embodiment, the plant protein based extrudate slabs comprise 19 to 29 wt % pea protein or soy protein.

In one embodiment, the single extruded slab or each slab in the layer of two or more extruded slabs has a thickness between 1 to 10 mm, preferably between 3 to 6 mm. In one embodiment, the extrudate comprises vinegar. In one embodiment, the extrudate comprises 2.0 to 6.0 wt % vinegar, preferably about 4.0 wt % of a 10 wt % vinegar solution, or equivalent thereof.

In one embodiment, the plant protein based extrudate further comprises insoluble particles, for example calcium carbonate. In one embodiment, the extrudate comprises 2 to 10 wt % calcium carbonate. The calcium carbonate is preferably precipitated calcium carbonate.

In one embodiment, the plant protein extrudate further comprises flavoring.

In one embodiment, the product of the invention is additive free.

In one embodiment, the product of the invention is free from animal products.

In one embodiment, the product does not comprise a breaded coating.

The invention further relates to a method of making a plant based extrudate for a meat or fish analogue, said method comprising
a. Feeding an extruder barrel with a composition comprising at least two different plant proteins and water;
b. Extruding the composition at a maximum temperature of between 130 to 190° C.;
c. Cooling the composition through a die;
d. Cutting the composition to form extrudate slabs; and
e. Optionally assembling to form a layer of two or more extrudate slabs.

In one embodiment, the die is a short die, preferably with a coat hanger geometry.

In one embodiment, the extrudate slabs are compressed prior to or during cooking.

In one embodiment, a connective tissue analogue and/or fat analogue is applied between the layer of two or more extrudate slabs.

In one embodiment, flavoring is (i) added with the connective tissue analogue and/or the fat analogue; and/or (ii) added by injecting into the composition and/or extrudate slabs.

In one embodiment, the layer of two or more extrudate slabs are cooked at a temperature to allow the connective tissue analogue to set and bind the extrudate slabs together.

### Connective Tissue Analogue

The connective tissue analogue may be used, for example, in a steak analogue product recipe. The connective tissue may comprise about 3 wt % Demi-glace Maggi vegetarian, about 9 wt % white egg powder, and about 80 wt % water.

The connective tissue analogue may be used, for example, in a fish analogue product recipe. The connective tissue analogue may comprise seaweed flour, konjac glucomannan, salt, potassium chloride, a starch, a plant protein and plant oil. Preferably, the seaweed flour is rich in kappa carrageenan. Seaweed extract may be prepared by boiling seaweed flakes in water. Soy protein isolate may be dispersed in the seaweed extract after it cools down. Oil may then be added while mixing. A coarse emulsion is formed by applying high shear. Seaweed flour, konjac flour, salts and flavors are hydrated in the emulsion. Heat is applied, for example 85° C. for 10 min. The hydrated dough or heated dough, for example at over 70° C., is typically applied by brushing, dosing, or spraying between the extrudate slabs. The assembled block with layered structure is tightly packed and then heated in an oven. After cooling down, a fish fillet with layers is formed.

### Meat Analogue Product

In one embodiment, the plant based meat analogue product is a meat analogue, for example a steak analogue, said steak analogue comprising a steak analogue extrudate comprising plant protein. In one embodiment, said steak analogue comprises at least two different plant proteins.

In one embodiment, the steak analogue extrudate comprises fibers which are aligned in substantially the same direction.

In one embodiment, the ratio of nominal maximal force values required to cut the product perpendicular to the fibre direction compared to parallel or along the fibre direction is greater than 1.55, preferably greater than 2.

In one embodiment, the steak analogue extrudate has a compact score of less than 1.2 and a chewy score of more than 2.3.

In one embodiment, a binding agent is present between the layer of two or more extruded slabs.

In one embodiment, the extrudate slabs are assembled with a connective tissue analogue and a fat analogue. The connective tissue analogue can be used in between the extrudate pieces to ensure the cohesion and the flavoring of the final steak analogue.

In one embodiment, the plant proteins are wheat gluten and a pea protein, preferably a pea protein isolate.

In one embodiment, the steak analogue extrudate comprises 5 to 15 wt % wheat gluten and 19 to 29 wt % pea protein, preferably pea protein isolate.

In one embodiment, the steak analogue extrudate further comprises insoluble particles, for example calcium carbonate, preferably precipitated calcium carbonate.

In one embodiment, the steak analogue extrudate further comprises flavoring.

In one embodiment, the steak analogue extrudate further comprises vinegar.

In one embodiment, the steak analogue extrudate comprises wheat gluten, pea protein isolate, and insoluble particles.

In one embodiment, the steak analogue extrudate comprises wheat gluten, pea protein isolate, insoluble particles, flavours, vinegar, and water.

In one embodiment, the steak analogue extrudate comprises about 12.5% wheat gluten, about 26.5% pea protein isolate, about 2% insoluble particles, about 3.3% flavours, vinegar, and about 53% water.

In one embodiment, the steak analogue extrudate comprises about 10% wheat gluten, about 24% pea protein isolate, about 2% insoluble particles, about 3.3% flavors, about 60.7% water, and colors.

In one embodiment, the steak analogue extrudate comprises about 12.5% wheat gluten, about 26.5% pea protein isolate, about 2% insoluble particles, about 3.3% flavours, vinegar, about 51.6% water, and colours.

In one embodiment, the steak analogue extrudate comprises wheat gluten in an amount less than 12.5%.

In one embodiment, the steak analogue extrudate comprises wheat gluten in an amount greater than 12.5%.

In one embodiment, the steak analogue extrudate comprises pea protein isolate in an amount less than 26.5%.

In one embodiment, the steak analogue extrudate comprises pea protein isolate in an amount greater than 26.5%.

In one embodiment, the steak analogue extrudate comprises water in an amount less than 53%.

In one embodiment, the steak analogue extrudate comprises water in an amount greater than 53%.

The invention further relates to a method of making a steak analogue product, said method comprising
a. Feeding an extruder barrel with a composition, said composition comprising plant protein, preferably comprising at least two different plant proteins, and water;
b. Extruding the composition, for example at a maximum temperature of between 130 to 190° C.;
c. Cooling the composition through a die, for example at a temperature between 70 to 80° C.;
d. Cutting the composition to form extrudate slabs; and
e. Cooking the slab or arranged layer of slabs to form a cooked slab or arranged layers of slab; and f. Optionally molding.

In one embodiment, the die is short coat hanger die, preferably a conic short coat hanger die, for example a conic short coat hanger die as described herein.

In one embodiment, the composition comprises between 45 to 65 wt % water.

In one embodiment, the slab or arranged layer of slabs are compressed prior to or during cooking.

In one embodiment, the binding solution comprises egg. In one embodiment, the binding solution comprises steak flavor. In one embodiment, the binding solution comprises starch, for example about 1% starch.

In one embodiment, flavoring is added with the binding solution or by injecting into the slab.

In one embodiment, the slabs are cooked in a steam oven, for example cooked in a steam oven under vacuum.

The invention further relates to a plant based steak analogue product made by a method according to the invention.

The invention further relates to a plant based roast analogue product made by a method according to the invention, for example substantially as described in the examples. In one embodiment, the steak analogue comprises about 12.3 wt % wheat Gluten, about 26.3 wt % pea protein isolate; about 4.0 wt % insoluble particle, and about 50 wt % water. In one embodiment, the connective tissue comprises about 3 wt % Demi-glace Maggi vegetarian, about 9 wt % white egg powder, and about 80 wt % water. In one embodiment, the fat analog comprises about 3.8 wt % soy protein isolate, about 43.8 wt % water, about 14 wt % fat, and about 4.8 wt % starch. In one embodiment, the steak analogue comprises about 69.2 wt % extrudate, about 27.6 wt % connective tissue analog, and about 3.2 wt % fat analog.

### Fish Analogue

In one embodiment, the plant based meat analogue product is a fish analogue.

The fish analogue may be in the form of, for example, a salmon, tuna, or white fish analogue, preferably in the form of a fish fillet.

In one embodiment, said fish analogue comprises a fish analogue extrudate comprising plant protein, preferably comprising at least two different plant proteins.

In one embodiment, the fish analogue extrudate comprises fibers which are aligned in substantially the same direction.

In one embodiment, the ratio of nominal maximal force values required to cut the product perpendicular to the fibre direction compared to parallel or along the fibre direction is greater than 1.55, preferably greater than 2.

In one embodiment, the fish analogue extrudate has a compact score of less than 1.2 and a chewy score of more than 2.3.

In one embodiment, a binding agent or connective tissue analogue is present between the layer of two or more extruded slabs.

In one embodiment, the connective tissue analogue is a viscous mass at temperatures above 70° C. In one embodiment, the connective tissue analogue releases oil when cooling down from temperatures above 70° C.

In one embodiment, the plant proteins are wheat gluten and pea or soy protein, preferably a protein isolate.

In one embodiment, the fish analogue extrudate comprises 5 to 15 wt % wheat gluten and 19 to 29 wt % pea or soy protein, preferably protein isolate.

In one embodiment, the fish analogue extrudate comprises between 50 to 65 wt % water.

In one embodiment, the fish analogue extrudate further comprises insoluble particles, for example calcium carbonate, preferably precipitated calcium carbonate.

In one embodiment, the fish analogue extrudate further comprises flavoring.

In one embodiment, the fish analogue extrudate further comprises vinegar.

In one embodiment, the fish analogue extrudate comprises wheat gluten, pea or soy protein isolate, and insoluble particles.

In one embodiment, the fish analogue extrudate comprises wheat gluten, pea or soy protein isolate, insoluble particles, flavours, vinegar, and water.

In one embodiment, the fish analogue extrudate comprises about 12.5% wheat gluten, about 26.5% pea or soy protein isolate, about 2% insoluble particles, about 3.3% flavours, vinegar, and about 53% water.

In one embodiment, the fish analogue extrudate comprises about 10% wheat gluten, about 24% pea or soy protein isolate, about 2% insoluble particles, about 3.3% flavors, about 60.7% water, and colors.

In one embodiment, the fish analogue extrudate comprises about 12.5% wheat gluten, about 26.5% pea or soy protein isolate, about 2% insoluble particles, about 3.3% flavours, vinegar, about 51.6% water, and colours.

In one embodiment, the fish analogue extrudate comprises wheat gluten in an amount less than 12.5%.

In one embodiment, the fish analogue extrudate comprises wheat gluten in an amount greater than 12.5%.

In one embodiment, the fish analogue extrudate comprises pea or soy protein isolate in an amount less than 26.5%.

In one embodiment, the fish analogue extrudate comprises pea or soy protein isolate in an amount greater than 26.5%.

In one embodiment, the fish analogue extrudate comprises water in an amount less than 53%.

In one embodiment, the fish analogue extrudate comprises water in an amount greater than 53%.

The invention further relates to a method of making a fish analogue product, said method comprising
a. Feeding an extruder barrel with a composition comprising plant protein, preferably comprising at least two different proteins and water;
b. Extruding the composition, preferably at a maximum temperature of between 130 to 190° C.;
c. Cooling the composition through a die, for example at a temperature between 70 to 80° C.;
d. Cutting the composition to form a slab; In one embodiment, the die is short coat hanger die, preferably a conic short coat hanger die, for example as described herein.

In one embodiment, the product comprises between 45 to 65 wt % water.

In one embodiment, the slab or arranged layer of slabs are compressed prior to or during cooking.

In one embodiment, the binding solution comprises seaweed flour, konjac flour, and salt. In one embodiment, the binding solution comprises between 0.5 to 0.9% seaweed flour, up to 0.6% konjac flour, and between 0.2 to 0.4% salt. For example, the binding solution may comprise about 0.8% seaweed flour and about 0.3% konjac flour and about 0.3% salt, for example NaCl. In one embodiment, the starch is tapioca starch. In one embodiment, the starch is native corn starch. In one embodiment, the binding solution comprises between 5 to 20 wt % fat analogue, preferably about 15 wt % fat analogue.

In one embodiment, the binding agent comprises a carrageenan source (preferably kappa-carrageenan), konjac glucomannan, a starch source, a potassium salt, and a plant protein and oil emulsion. Seaweed extract, for example dashi, can also be added.

In one embodiment, the fat analogue is heated to above 70° C. In one embodiment, the fat analogue is brushed or loaded between extrudates. In one embodiment, the assembled block with layered structure is vacuum packed and heated in oven to re-melt the fat analogue. While heating, the fat analogue can be partially melted. This provides the effect of flakiness when cutting by fork.

The invention further relates to a plant based fish analogue product made by a method according to the invention, preferably as substantially described in the examples.

In one embodiment, the fish analogue is a tuna or salmon analogue. The fish analogue may be a fish finger analogue made by a method according to the invention, preferably as substantially described in the examples.

Where the fish analogue is a salmon analogue, orange or pink color may be added to the extrudate. The connective tissue analogue may comprise seaweed flour, konjac glucomannan, salt, potassium chloride, a starch, a plant protein and plant oil. Preferably, the seaweed flour is rich in kappa carrageenan. Seaweed extract may be prepared by boiling seaweed flakes in water. Soy protein isolate may be dispersed in the seaweed extract after it cools down. Oil may then be added while mixing. A coarse emulsion is formed by applying high shear.

Seaweed flour, konjac flour, salts and flavors are hydrated in the emulsion. Heat is applied, for example 85° C. for 10 min. The hydrated dough or heated dough, for example at over 70° C., is typically applied by brushing, dosing, or spraying between the extrudate slabs. The assembled block with layered structure is tightly packed and then heated in an oven. After cooling down, a fish fillet with layers is formed.

In a preferred embodiment, the method of making a plant based meat analogue product comprises the use of a short die. The length of the die is the distance between the entrance of the die and the slit exit.

More specifically, the method of making a plant based meat and fish analogue product comprises a short die with a cylindrical channel and an extension chamber situated before the slit exit.

In an embodiment, the die is a cooling die, for example a cooling die as described herein. In one embodiment, the cooling die is a short die. In one embodiment, the short die has a cylindrical channel and preferably comprises and extension chamber situated before the slit exit.

In an embodiment, the product comprises a slab or arranged layer of slabs having a structure composed of long fibres organized in fibres bundles which are separated by voids.

In an embodiment, the fibres have an intermediate elasticity.

### DETAILED DESCRIPTION OF EXAMPLE EMBODIMENTS

Detailed embodiments of methods, products, and uses are disclosed herein. However, it is to be understood that the disclosed embodiments are merely exemplary and may be embodied in various forms. Therefore, specific functional details disclosed herein are not to be interpreted as limiting, but merely as a basis for the claims as a representative example for teaching one skilled in the art to variously employ the present disclosure. Features from product, method and use embodiments of the invention may be freely combined.

As used herein, “aligned in substantially the same fiber direction” should be taken to mean that greater than 50% of sheared fibers are aligned in the same direction +/−15 degrees. “Substantially equidistant from the inside of the insert” should be taken to mean that greater than 80%, more preferably 90%, most preferably all of the points on the core periphery at the widest diameter of the core are equidistant from the inside of the insert.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range.

The products disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein unless explicitly and directly stated otherwise.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

As used herein, the term “additive” includes one or more of hydrocolloids (e.g. carboxymethylcellulose, methylcellulose, hydroxypropylmethylcellulose, konjac gum, carragenans, xanthan gum, gellan gum, locust bean gum, alginates, agar, gum arabic, gelatin, Karaya gum, Cassia gum, microcrystalline cellulose, ethylcellulose); emulsifiers (e.g. lecithin, mono and diglycerides, PGPR); whitening agents (e.g. titanium dioxide); plasticizers (e.g. glycerine); anti-caking agents (e.g. silicon-dioxide).

All percentages expressed herein are by weight of the total weight of the plant based meat analogue and/or the corresponding emulsion unless expressed otherwise.

The term “conic” refers to the shape of the core of the extrusion die. Preferably, the core is a conic core with a circular symmetry. The core may be an alternative shape. Other forms such as an elliptical cone or a pyramidal cone with multiple edges, for example greater than six, or seven, or eight, or nine, or ten edges, are also possible.

The terms “food,” “food product” and “food composition” mean a plant based meat or fish analogue product or composition that is intended for ingestion by an animal, including a human or pet, and provides at least one nutrient to the animal.

A “plant based meat or fish analogue product” resembles meat that has been derived from an animal source, in terms of appearance, texture, and physical structure. As used herein, a plant based meat analogue does not include meat derived from an animal source.

A short die is defined as a die in which L/ΠD ratio is less than 1, wherein L is the die length And ΠD is the average exit perimeter. The L/πD ratio defines the length divided by average exit perimeter (πD with D=(d1+d2)/2). The stresses are applied in the direction and perpendicular to the flow direction of the dough, respectively for L and πD. Typically, the L/ΠD ratio is between 0.1 to 0.99, or about 0.45, or about 0.513, or about 0.53. The length is defined as the length through which a material, for example a dough or a composition, travels when the die is in use. The die width is defined as the longest dimension of a planar section of the die through which a material, for example a dough or a composition, travels when the die is in use.

A specific feature of the plant based meat or fish product is the presence of a macroscopic fibrillar protein-based structure.

The plant based meat or fish analogue is preferably made using a cooling die as described herein. The cooling die creates plant based meat and fish analogues with fibres which are formed in the die in a substantially perpendicular direction to the flow path of the die.

In one embodiment, the die comprises an inlet and an outlet, or die exit. The die is preferably a short die, The die may include a line connection that directs a dough into a die inlet. The line connection may be connected to other elements of a meat analogue production system, for example an extrusion device, to receive raw and/or pre-processed meat analogue and/or dough for processing to make a plant based meat or fish analogue product of the invention.

The die comprises an insert, also referred to as the main body, a core, preferably a conic core, and a flow path. Preferably, the die is a short die. Preferably, the die is of the coat hanger type. The coat hanger geometry is derived from the plastic film casting die and is characterized by an expansion chamber situated right before the slit exit of the die. This specific geometry allows to create a succession of compression, decompression, compression and decompression to the atmospheric pressure which creates a specific fiber bundle organization.

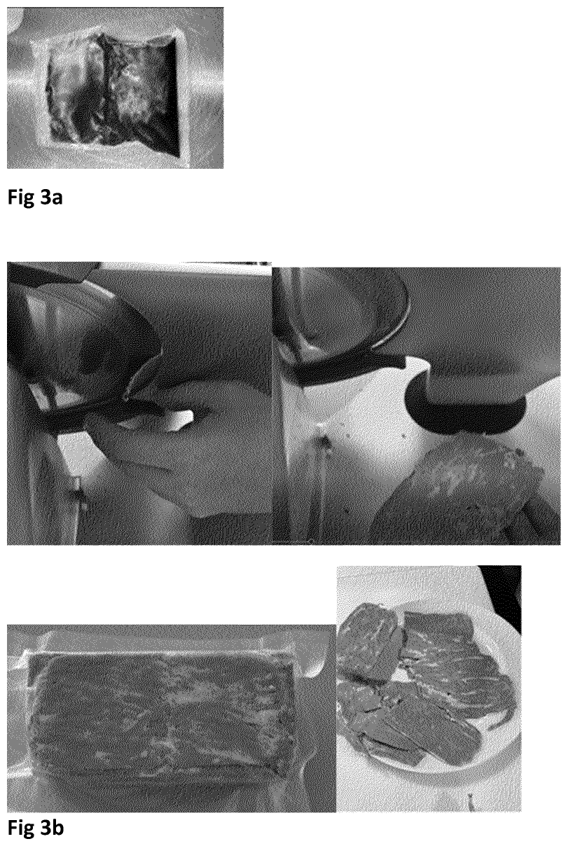

Preferably, the die comprises means to facilitate movement of the core inside the insert. Referring to FIG. 4, the die 10 comprises an insert or main body 20, and a conic core 30. Frame 40 is connected to the conic core 30 and the insert or main body 20 and facilitates movement of the conic core 30 inside the insert or main body 20. Frame 40 provides a concentric spatial relationship between the conic core 30 and the insert or main body 20.

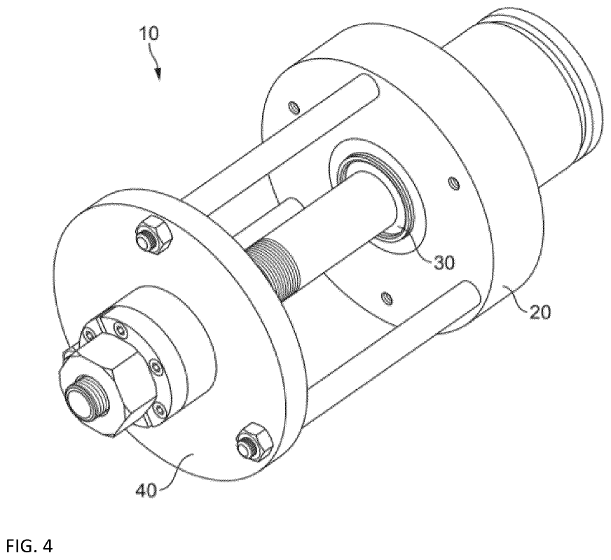

The flow path is the space between the insert or main body and the core. The insert and the core comprise a first interior surface and a second interior surface, respectively. In one embodiment, the first interior surface and/or the second interior surface is sanded. In one embodiment, the first interior surface and/or the second interior surface having a surface roughness rugosity value Ra of at least 3.2. The first interior surface and the second interior surface define the flow path. The insert and/or core comprise a cooling means. Referring to FIG. 5, the insert 20 and the core 30 include a first interior surface 22 and a second interior surface 32, respectively. The first interior surface 22 and the second interior surface 32 define a flow path 23. The flow path 23 represents the route of the dough as it is directed through the die 10.

Typically, the first interior surface and the second interior surface have a combined surface area of between 18000 mm² to 25000 mm², or about 19748 mm², or about 19777 mm², or about 20125 mm², or about 20304 m², or about 21352 mm², or about 21370 mm², or about 21399 mm².

Typically, the flow path has a volume of between 20000 mm² to 35000 mm², or about 23565 mm², or about 24149 mm², or about 24668 mm², or about 27005 mm², or about 29641 mm², or about 29784 mm², or about 29880 mm², or about 30594 mm².

The specific surface area is the ratio of surface area of the die in contact with the dough to the volume through which the dough flows. The specific surface area is a factor that would impact the relative ratio of shear and elongational stresses acting on the dough while it moves through the die. Thus, the orientation of the fibers and the stress experienced by the fibers is linked with the specific surface area. Typically, the specific surface area is between 0.58 to 0.99, or about 0.66, or about 0.68, or about 0.71, or about 0.73, or about 0.80, or about 0.88, or about 0.91.

The L/2D ratio defines the length over which shear stress is applied in the direction and perpendicular to the flow direction of the dough, respectively L and D. Typically, the L/2D ratio is between 0.65 to 0.99, or about 0.71, or about 0.81, or about 0.83, or about 0.96.

The insert 20 and/or the core 30 may comprise a cooling means 24, 25. The cooling means controls the temperature of the dough as it is directed through the die. The core may comprise a cooling means to control the temperature of the dough. The insert may comprise a cooling means to control the temperature of the dough. Referring to FIG. 5, the cooling means 25 of the core 30 may be controlled independently from the cooling means 24 of the insert 20. Preferably, the cooling means 25 of the core 30 and the cooling means 24 of the insert 20 are not physically connected, for example the coolant or cooling fluid used in the cooling means of the core 30 is not the same coolant or cooling fluid used in the cooling means of the insert 20.

The frame may be connected to the insert by connecting means, for example axes or rods. A positioning means, for example a screw system, may be used to position the core inside the insert. Referring to FIG. 5, the die 10 includes a frame 40. The frame 40 may be connected to the insert 20 by axes 42. The frame 40 provides a concentric spatial relationship between the core 30 and the insert 20. The frame 40 may include a screw system 44. The screw system facilitates movement of the core 30 inside the insert 20. The movement may be parallel to a z geometrical axis of the insert 20. The core 30 and the insert 20 may be fixed at any suitable position to form a flow path 23 between the core 30 and the insert 20.

The gap between the core and the insert forms the die exit. Typically, the die exit is circular. Typically, the die exit has a defined gap size (or exit slit gap). The gap size is the difference between the die exit outer diameter and the die exit inner diameter.

Typically the die exit outer diameter is between 45 mm to 55 mm. For example, the die exit outer diameter is between 47.5 mm to 49.5 mm, or about 48.5 mm. For example, the die exit outer diameter is between 49 mm to 51 mm, or about or 50 mm. For example, the die exit outer diameter is between 51 mm to 53 mm, or about 52 mm.

Typically, the die exit inner diameter is between 41 mm to 50 mm. For example, the die exit inner diameter is between 43 mm to 45 mm, or about 44 mm. For example, the die exit inner diameter is between 43.5 mm to 45.5 mm, or about 44.5 mm. For example, the die exit inner diameter is between 46 mm to 48 mm, or about 47 mm.

Typically, the die exit has a gap size of between 1 mm to 5.5 mm, or between 1 mm to 5 mm, or between 1.4 to 3.5 mm. In one embodiment, the gap size may be between 1.4 to 1.6 mm. In one embodiment, the gap size may be about 1.5 mm. In one embodiment, the gap size may be between 2.4 to 2.6 mm. In one embodiment, the gap size may be about 2.5 mm. In one embodiment, the gap size may be between 2.9 to 3.1 mm. In one embodiment, the gap size may be about 3 mm. In one embodiment, the gap size may be between 3.4 to 3.6 mm.

In one embodiment, the gap size may be about 3.5 mm. In one embodiment, the gap size may be between 4.7 to 4.9 mm. In one embodiment, the gap size may be about 4.8 mm.

Typically, the exit slit length is between 5 mm to 30 mm. For example, the exit slit length is between 10 mm to 12 mm, or about 11.15 mm. For example, the exit slit length is between 20.7 to 22.7 mm, or about 21.7 mm. For example, the exit slit length is between 13.5 mm to 16 mm, or about 14.73 mm. For example, the exit slit length is between 23.5 mm to 26 mm, or about 24.73 mm.

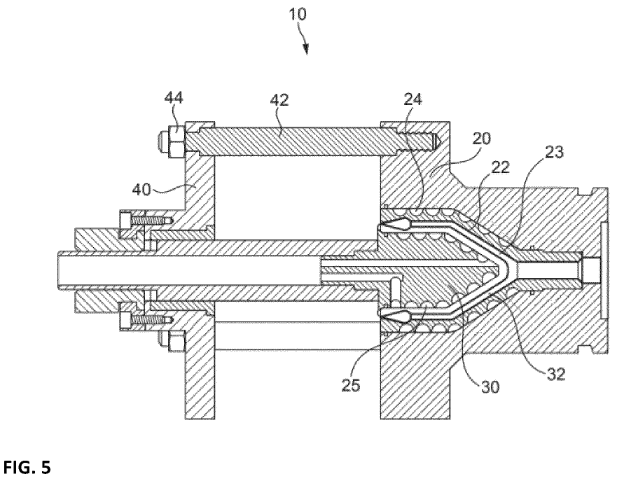

Typically, the die exit has an external perimeter of greater than 400 mm, preferably between 400 mm and 500 mm, for example 450 mm. The core and insert have a concentric spatial relationship. A double helical mantle may be screwed inside the insert. The cooling means may be regulated by a temperature sensor (not shown). Referring to FIG. 6, a gap between the conic core and the insert forms the die exit 26. A double helical mantle 27 may be screwed inside the insert 20. The double helical mantle 27 may have an inlet connection 28 and an outlet connection 29 to a cooling means.

Typically, the core comprises a cylindrical section and a cone. The cylindrical section has a defined cylindrical length. The cone can also be called the summit end.

Typically, an expansion chamber is situated between the slit exit and the summit end. The expansion chamber has a radius R2 and R2.7 as illustrated herein. For example, the R2.7 radius can be between 25° to 35°, or about 29.36°.

Typically, the cylindrical length is between 15 mm to 45 mm, or about 17.89 mm, or about 18 mm, or about 24.65 mm, or about 28.55 mm, or about 34.65 mm, or about 42.5 mm.

Typically, the cone or summit end is rounded. Typically, the cone length is between 20 mm to 45 mm, or between 25 mm to 30 mm, or about 27 mm, or between 34 mm to 39 mm, or about 36 mm.

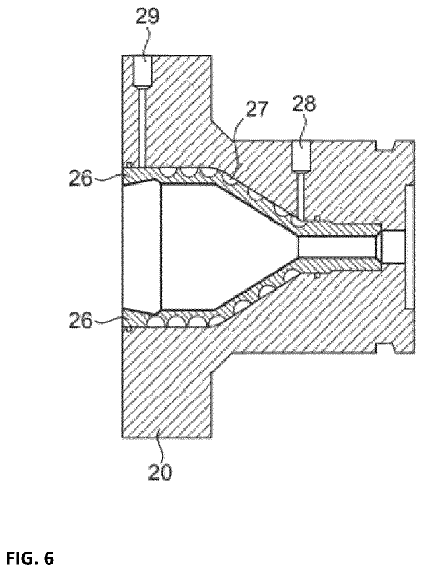

The summit end may comprise a helical channel on its surface. A mantle may be adapted to plug on the summit end. This may create a cooling circuit inside the core. The core may be connected to the frame by a central axis. Referring to FIG. 7, the conic core 30 comprises a summit end 31. The summit end 31 is rounded. Typically, the summit end has a cone apex radius R6 as illustrated herein. The summit end 31 has a helical channel 33 on its surface 34. A conic mantle 35 is adapted to plug on the summit end 31 to create a cooling circuit 36 inside the conic core 30 with an inlet connection 37 and an outlet connection 38 to the external cooling. The conic core 30 is connected to the frame by a central axis 39, thereby allowing coolant or cooling fluid to be fed to the conic core cooling circuit 36.

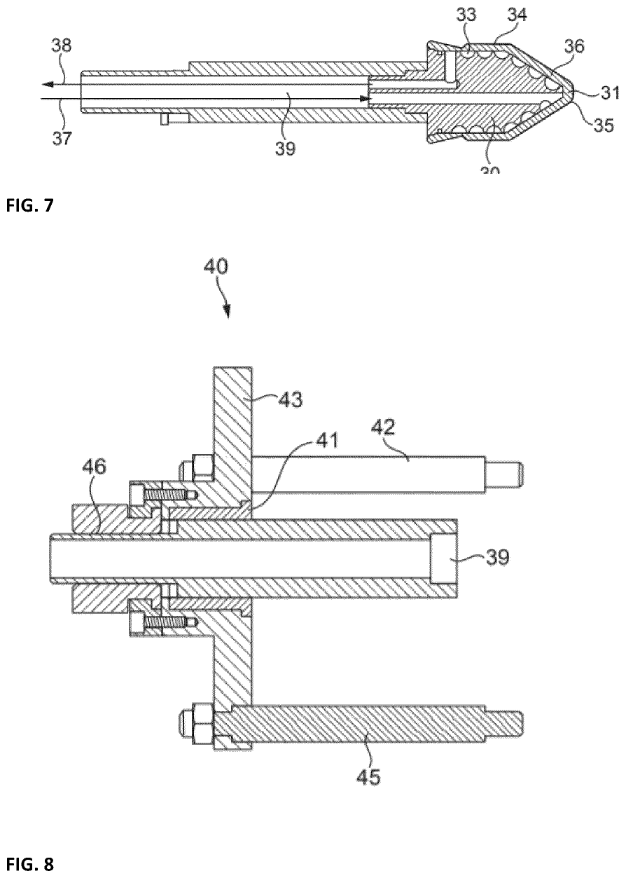

The frame further comprises guiding means, for example a screw thread. This facilitates the accurate positioning of the core inside the insert. The frame and the insert can also be maintained in a fixed position without modification. It also further enables the flow path to be adjusted. Referring to FIG. 8, the frame 40 is composed of a bearing guide 41 inside a flange 43 connected to the insert by three screwed rods 45 with an adapted geometry to set the bearing guide 41 centered to the insert. A central axis 39 may be connected on one side to the conic core and on the other side to the bearing guide 41 with fine thread 46 to allow an accurate positioning of the conic core inside the insert and further enables the flow path to be adjusted.

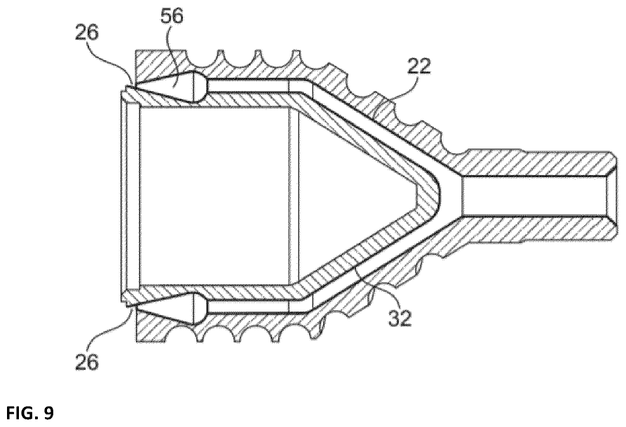

In an embodiment, the die imposes periodic pressure variation on the dough. The conic core can be modified for specific meat analogue applications or to create specific fibrous structures. The first interior surface and the second interior surface may each comprise a helicoidal channel. The first interior surface and the second interior surface may each comprise periodical grooves. Referring to FIG. 9, the first interior surface 22 and the second interior surface 32 comprise a helicoidal channel 56 to orientate the dough shape in a curved direction. This enables mimicking of a fish meat analogue structure. In other applications, the first interior surface 22 and the second interior surface 32 may comprise periodical grooves. These can induce dough flow disturbance to create specific fibrous structures.

In an embodiment, the core comprises a cylindrical section and a summit end. The angle of the surface between the cylindrical section of the core and the summit end of the core can be varied, for example the angle of the surface at a point equidistant between the cylindrical section of the core and the summit end of the core can be varied. The angle of the surface between the cylindrical section of the core and the summit end of the core, for example the angle of the surface at a point equidistant between the cylindrical section of the core and the summit end of the core, can be between 100° to 170°, or between 110° to 160°, or between 120° to 150°, or between 130° to 140°, or about 135°. Where the angle is 135° or less, the angle of the surface between the cylindrical section of the core and the summit end of the core, for example the angle of the surface at a point equidistant between the cylindrical section of the core and the summit end of the core, can be between 100° to 135°, or between 105° to 130°, or between 110° to 125°, or between 115° to 120°, or about 117°. Where the angle is 135° or more, the angle of the surface between the cylindrical section of the core and the summit end of the core can be between 135° to 170°, or between 140° to 165°, or between 145° to 160°, or between 150° to 155°, or about 152°.

As shown in FIG. 7, the angle 47 of the surface between the cylindrical section of the conic core and the summit end 31 of the conic core 30 can be increased or decreased, thereby adjusting the pressure gradient in the flow path 23. If angle 47 is decreased, for example to equal or less than 135°, the flow path of the dough will widen at the summit end 31 of the conic core 30 and then the dough will increase in pressure as the flow path 23 is reduced. In another embodiment, if angle 47 is increased, for example to equal or greater than 135°, the flow path of the dough will narrow at the summit end 31 of the conic core 30 and then the flow of the dough will widen as the flow path 23 is increased. The diameter 48 of the conic core 30 or the distance 51 from the summit end 31 of the conic core 30 to the die entrance 49 is also adjusted when angle 47 is modified to adjust the gap 50 in the cylindrical section of the conic core 30. By adjusting the values of angle 47, diameter 48, and distance 51, the structure and texture of the resulting product at the die exit 26 can be altered. For example, the expansion, density, and fiber organization can be altered.

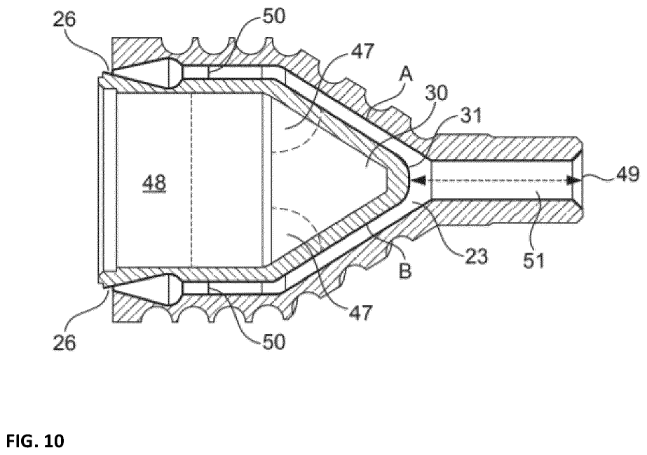

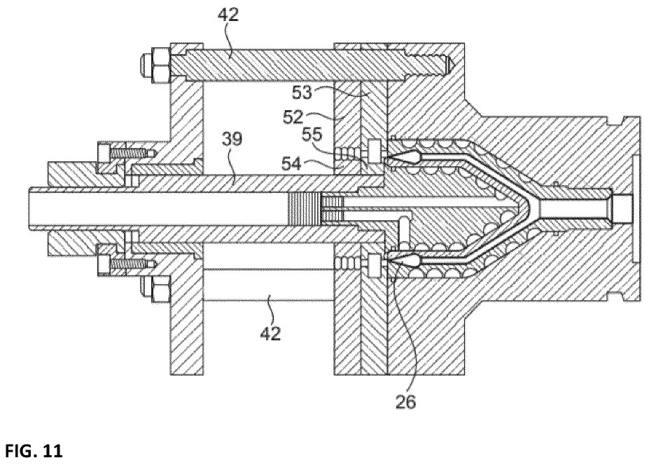

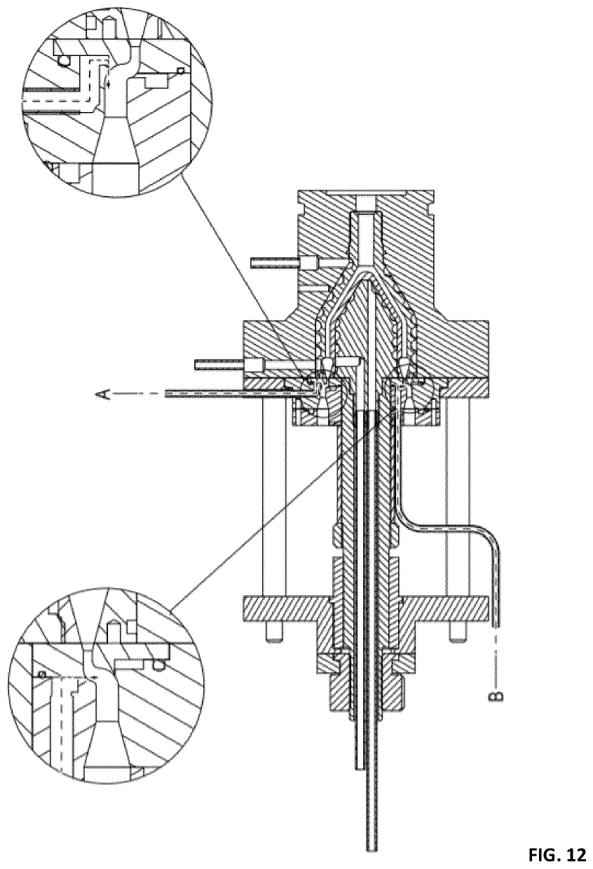

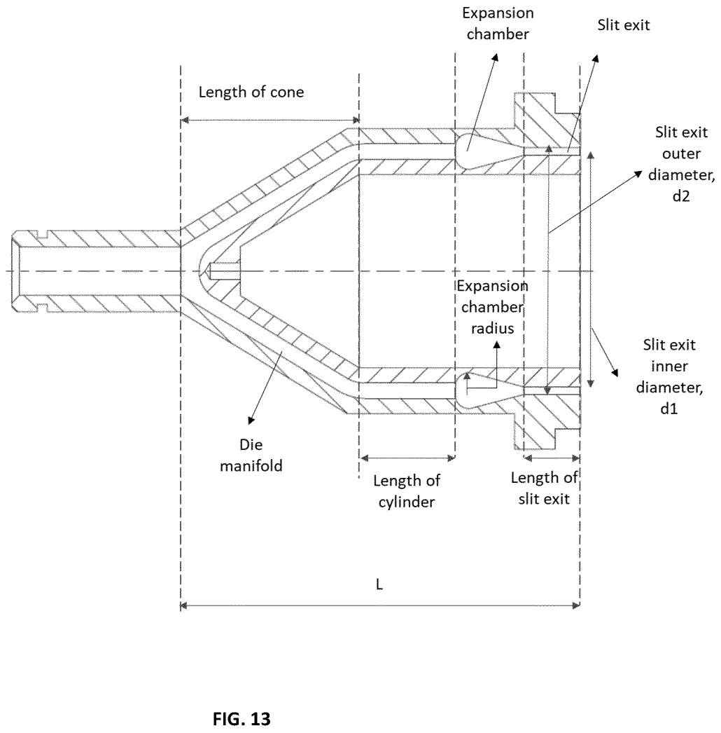

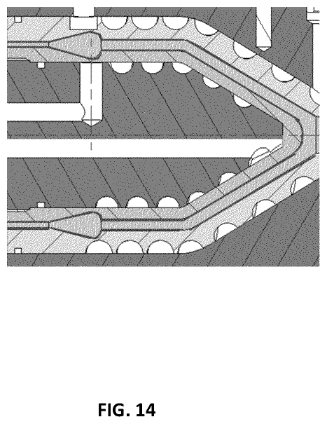

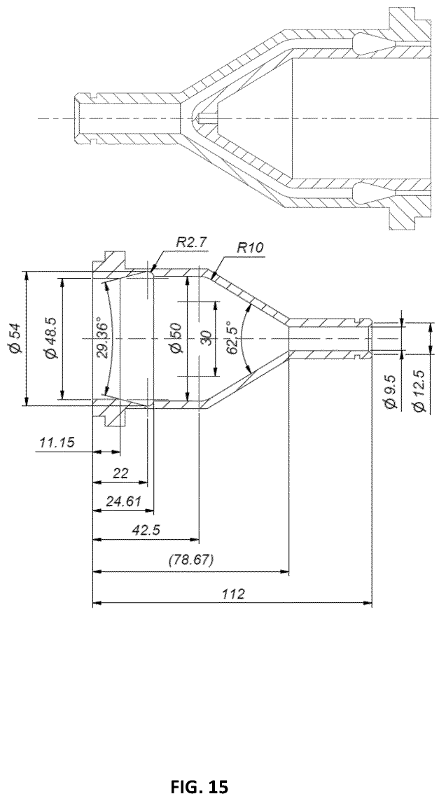

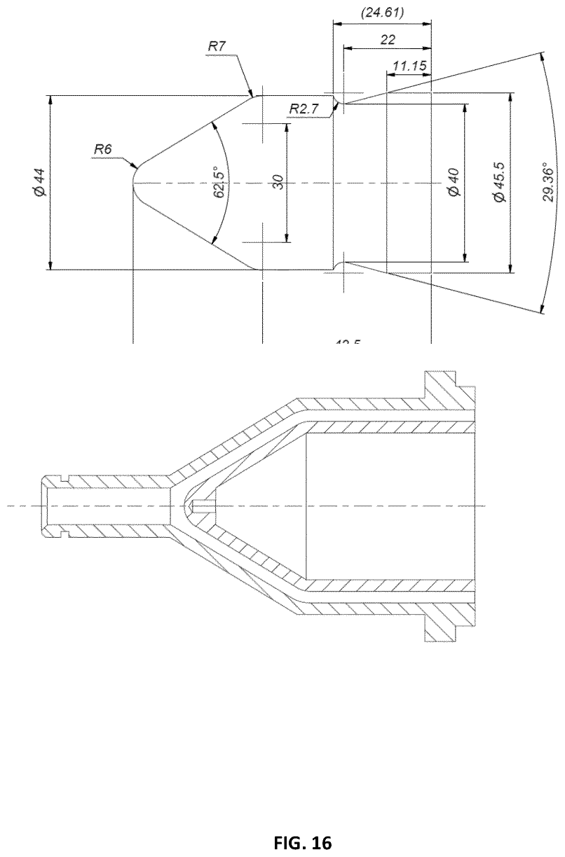

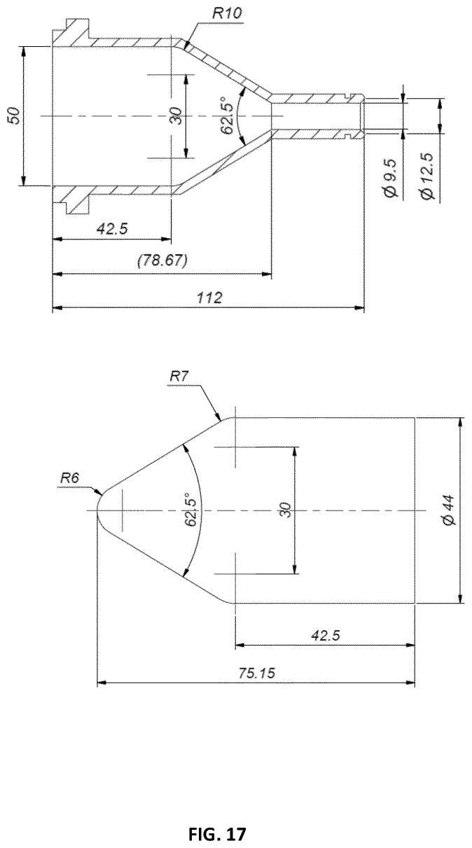

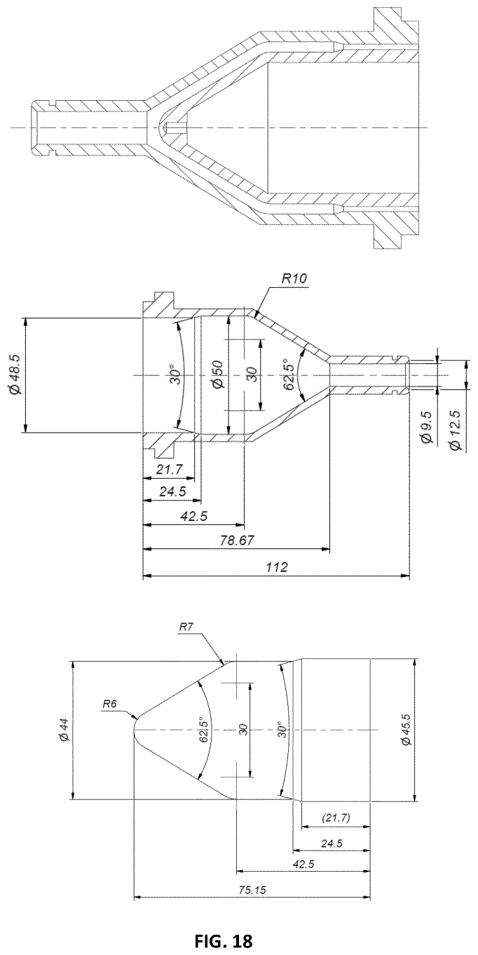

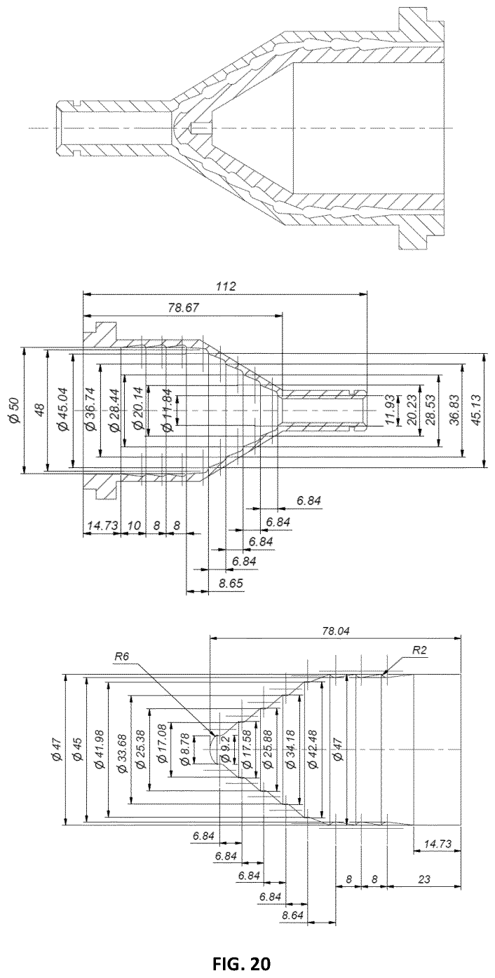

In an embodiment, the die is substantially similar in its dimensions to those described or illustrated herein, for example to any one of those illustrated in FIGS. 13 to 23.

The conic die of the invention may be in the form of at least one of the following embodiments.

In one embodiment, the conic die comprises a) a cylindrical section; b) a coat hanger geometry, the coat hanger geometry may be characterized by having an expansion chamber proximal to a circular slit exit; c) the circular slit exit may have a gap size of about 1.5 mm; and d) the expansion chamber may be in the form of a ring or annulus zone.

In one embodiment, the conic die comprises a) cylindrical geometry made up of a conic entrance and a cylindrical section; b) cylindrical geometry is characterized by no expansion zone, no restriction, continuous gap size, for example 3 mm, from the entrance until the exit of the die.

In one embodiment, the conic die comprises a) cylindrical geometry with a slit exit, for example a long slit exit, comprising a conic entrance followed by a cylindrical section; b) the cylindrical geometry is characterized by no expansion zone and but with a restriction having a circular slit, for example a long circular slit, at the exit, for example 1.5 mm slit.

In one embodiment, the conic die comprises a) cylindrical geometry with a slit exit, for example a shorter slit exit, comprising a conic entrance followed a cylindrical section; b) the cylindrical geometry is characterized by no expansion zone and but with a restriction having a short circular slit at the exit, for example a 1.5 mm slit.

In one embodiment, the conic die comprises a) multiple restrictions on its internal surfaces b) a conic entrance c) a cylindrical section having multiple and successive narrowing and expansion zones d) a circular slit exit, for example a 1.5 mm slit exit.

In one embodiment, the conic die comprises a) multiple misaligned restrictions on its internal surfaces b) a conic entrance c) a cylindrical section having multiple misaligned and successive narrowing and expansion zones d) a circular slit exit, for example a 1.5 mm slit exit. The consequence of the multiple misaligned restrictions is increase in the path length between the conic entrance and the exit of the die.

In one embodiment, the conic die comprises a) multiple restrictions on its internal surface b) a conic entrance c) a cylindrical section having multiple and successive narrowing and expansion zones d) a circular slit exit, for example a 3.5 mm slit exit.

In one embodiment, the conic die comprises a) a conic entrance b) a cylindrical section c) the coat hanger geometry is characterized by an expansion chamber (ring or annulus zone), a the circular slit exit (1.5 mm) and a shoulder after the conical part.

In one embodiment, one or more internal surface is sanded, wherein the sanded surface has a rugosity value Ra of at least 3.2. In one embodiment, the friction force is increased. In one embodiment, the one or more internal surface comprises restrictions, for example misaligned restrictions.

In an embodiment, the die comprises one or more expansion zones, for example, 1, 2, 3, 4, 5, 6, 7, 8, 9, 10, or more expansion zones.

In an embodiment, the expansion zones are aligned. In one embodiment, the expansion zones are periodical. In one embodiment, the expansion zones are aligned and periodical. In an embodiment, the expansion zones are not aligned.

In an embodiment, at least one interior surface comprises a shoulder, for example a shoulder on the conic core. In an embodiment, the surface geometry of at least one internal surface of the die creates pressure variation without compression and decompression within the die. In one embodiment, the first and/or second interior surface comprise multiple small-scale variations of amplitude in the height of their surface, thereby disrupting the flow path.

In an embodiment, the core is connected to a motor to facilitate rotation of the core. This creates additional rotating shear to create an altered extrudate structure. In another embodiment, the core does not freely rotate.

In an embodiment, the die comprises gas or steam injecting means.

In an embodiment, the die further comprises one or more complementary rings situated adjacent to the die, preferably at the die exit. Preferably, a complementary ring injects gas, for example nitrogen gas, through a slit, for example a circular slit. Preferably, a complementary ring injects steam through a slit, for example a circular slit. Preferably, a complementary ring injects coating through a slit, for example a circular slit. In one embodiment, a complementary ring injects fat or fat analog by means of a circular slit connected to a fat pumping system. In one embodiment, a complementary ring injects ingredients, for example flavor and/or color solutions. If extrusion dies, for example conic dies, are vertically stacked, then multi-structure products can be manufactured.

Each complementary ring can add a post-extrusion process step. The process step sequence can be in a different order from herein described depending on the targeted product structure and properties. Referring to FIG. 8, one or more complementary rings 52 to 55 are situated adjacent to the die exit 26. Internal rings 54 and 55 are attached to the central axis 39. External rings 52 and 53 are maintained in position by three external axes 42. Referring to FIG. 9, fat analogue may be injected via inlets A and B using complementary rings situated adjacent to the die exit.

In one embodiment, a heat treatment is applied outside the die, for example to obtain jellification of fat emulgel, or to sterilize the meat analogue extrudate. The heat treatment can be provided by water or steam circulation, for example in a double jacket ring. In one embodiment, a complementary ring applies steam on the surface of the meat analogue extrudate. In one embodiment, a complementary ring applies a jellifying composition to create a bilayer structure on the external surface of the meat analogue extrudate. The gelling of the solution can be induced by an additional ring to heat the external layer and to provoke external layer reticulation. The bi-layered structure can be cut in one direction to obtain a bi-structure slab.

In one embodiment, a cutting means cuts the meat analogue extrudate as it exits the die at one point to obtain a single piece of extrudate. In one embodiment, the cutting means cuts the meat analogue extrudate as it exits the die at more than one point to obtain more than one piece of extrudate. In one embodiment, a cutting means cuts the meat analogue extrudate perpendicularly to the flowing direction with a moving blade to obtain a spring shape. In one embodiment, a cutting means cuts the meat analogue extrudate in both directions to obtain chunks of defined sizes (granulator).

The invention further provides a method of making a meat analogue comprising a vegetable protein, the method comprising applying heat and/or pressure to a dough in an extruder; passing the dough through a die that is part of and/or is connected to the extruder, the die comprising an insert, a core, preferably a conic core, and a flow path; wherein the flow path is defined by the insert and the core. Preferably, the die is according to the invention as described herein. Preferably, the die is a short die of the coat hanger type.

Preferably, the extruder operates at a screw speed of 50 to 400 rpm. The extruder may operate at a mass flow of greater than 20 kg/h, or greater than 75 kg/h, or greater than 100 kg/h, or greater than 200 kg/h, or greater than 300 kg/h, or greater than 1000 kg/h, or up to 5000 kg/h, or up to 100000 kg/h. Preferably, the extruder operates at a temperature of 140° C. to 200° C. The dough can be prepared in a location selected from the group consisting of (i) a mixer from which the dough can be pumped into the extruder and (ii) the extruder, for example by separately feeding powder and liquid into the extruder.

In an embodiment, the method further comprises maintaining the insert and/or the conic core at a constant temperature.

In an embodiment, the method further comprises adjusting the constant temperature of the insert and/or the conic core based on temperature information received from a temperature sensor that senses a temperature of the insert and/or the conic core as the dough passes through the flow path.

In an embodiment, the method comprises injecting gas or steam into the die as the dough passes through the flow path. Preferably, the gas is nitrogen gas.

In an embodiment, the dough is directed through the flow path at a massic flow rate of 20 kg/h to 300 kg/h, preferably 75 kg/h to 300 kg/h.

In an embodiment, the meat analogue comprises fibres which are formed in a substantially perpendicular direction to the flow path of the die. In an embodiment, the values of the ratio of the maximum force to cut the fibres in transversal direction to the maximum force to cut the fibres in longitudinal direction with respect to the direction of the flow path of the die is about 2, more preferably 2 or greater.

In an embodiment, the method further comprising cutting the meat analogue after the meat analogue exits the die.

The invention further relates to the use of a core, preferably a conic core with a circular symmetry, in a die as described herein to make a meat analogue comprising a vegetable protein.

The invention further relates to the use of a die as described herein to make a meat or fish analogue comprising a vegetable protein. Preferably, the invention relates to the use of a die to make a meat or fish analogue comprising a vegetable protein, wherein said die comprises a conic core with a circular symmetry.

The meat or fish analogue extrusion system may first preprocess the dough at a dough preparation area. For example, the dough may include multiple ingredients, and the multiple ingredients may require mixing prior to further processing. The mixing may be performed by hand and/or may be performed by a mechanical mixer, for example a blender.

The dough may be placed in a pump, for example a piston pump, of the meat analogue extrusion system. The dough may be placed in the pump by hand, and/or may be automatically transported from the dough preparation area to the pump. The pump may transmit the dough through a line. The line may be connected to an extruder. For example, the line may be connected to a twin screw extruder. In an embodiment of the meat analogue extrusion system, the line is not included, and the pump is connected directly to the extruder.

The extruder, for example a twin screw extruder, may apply a pressure to the dough to move the dough from a side of the extruder with the pump to an opposite side of the extruder. The extruder may additionally or alternatively apply heat to the dough. The extruder may additionally or alternatively be configured with an injection port to inject water and/or another material into the dough as the dough moves though the extruder.

The steps included herein have been given in an order, but the steps disclosed herein are not limited to being performed in the order presented herein. For example, a cooling step may occur before or after passing the dough through the die.

The dough and/or meat analogue may include a raw material. In a preferred embodiment, the raw material is a non-animal substance. Non-limiting examples of suitable non-animal protein substances include pea protein, wheat gluten such as vital wheat gluten, corn protein, for example ground corn or corn gluten, soy protein, for example soybean meal, soy concentrate, or soy isolate, rice protein, for example ground rice or rice gluten, cottonseed, peanut meal, whole eggs, egg albumin, milk proteins, and mixtures thereof. Preferably, the non-meat protein substances are pea protein, wheat gluten, and/or soy protein, and mixtures thereof.

In some embodiments, the raw material does not comprise a meat and comprises gluten, for example wheat gluten. In some embodiments, the raw material does not comprise a meat and does not comprise any gluten.

The raw material may optionally comprise a flour. If flour is used, the raw material may include protein. Therefore, an ingredient may be used that is both a vegetable protein and a flour. Non-limiting examples of a suitable flour are a starch flour, such as cereal flours, including flours from rice, wheat, corn, barley, and sorghum; root vegetable flours, including flours from potato, cassava, sweet potato, arrowroot, yam, and taro; and other flours, including sago, banana, plantain, and breadfruit flours. A further non-limiting example of a suitable flour is a legume flour, including flours from beans such as favas, lentils, mung beans, peas, chickpeas, and soybeans.

In some embodiments, the raw material may comprise a fat such as a vegetable fat. A vegetable oil, such as corn oil, sunflower oil, safflower oil, rape seed oil, soy bean oil, olive oil and other oils rich in monounsaturated and polyunsaturated fatty acids, may be used additionally or alternatively.

The raw material may include other components in addition to proteins and flours, for example one or more of a vitamin, a mineral, a preservative, a colorant and a palatant.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims. Further, the present embodiments are thus not to be limited to the precise details of methodology or construction set forth above as such variations and modification are intended to be included within the scope of the present disclosure. Moreover, unless specifically stated any use of the terms first, second, etc. do not denote any order or importance, but rather the terms first, second, etc. are merely used to distinguish one element from another.

### EXAMPLES

### Example 1

### Steak Analogue

The extrudates were assembled with a connective tissue analogue and a fat analogue. The connective tissue analogue was used in between the extrudate pieces to ensure the cohesion and the flavouring of the final steak analogue. The assembled structures were rolled, placed in a plastic bag, sealed under vacuum and cooked in a steam oven.

| Steak extrudate recipe | g/100 g |
|---|---|
| Wheat Gluten | 12.3 |
| Pea protein isolate | 26.3 |
| Insoluble particles | 4.0 |
| Flavors | 3.3 |
| Colors | 0.1 |
| Preservative | 4.0 |
| Water | 50.0 |

| Connective tissue | |
|---|---|
| analogue recipe 1 | g/100 g |
| Demi-glace Maggi | 3.0 |
| Vegetarian | |
| Flavors | 8.0 |
| White egg powder | 9.0 |
| Water | 80.0 |

| Fat analog | g/100 g |
|---|---|
| Soy protein isolate | 3.8 |
| Water | 43.8 |
| Oil | 32.7 |
| Fat | 14.0 |
| Flavors | 0.9 |
| Starch | 4.8 |

The final composition of the loaf was the following:

| Assembly | g/100 g |
|---|---|
| Extrudate pieces | 69.2 |
| Connective tissue analogue | 27.6 |
| Fat analogue | 3.2 |

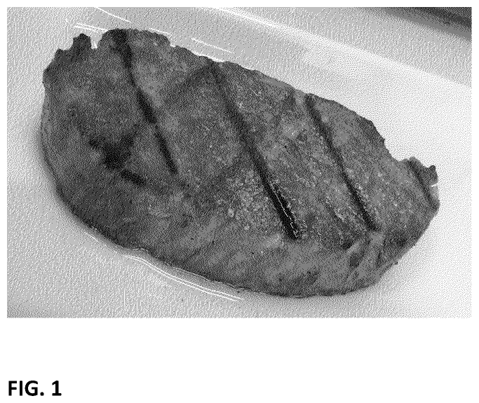

The loaf was cut in slices of 2-3 cm to prepare the steak piece (FIG. 1)

### Example 2

### Roast Analogue

The same extrudate, connective tissue analogue and fat analogue as the steak application was used for the roast application.

For the roast, the loaf was cut in section of roughly 10 cm length and coated with a marinade preparation.

| Marinade | g/100 g |
|---|---|
| Liquid brown malt | 29.0 |
| Soya sauce | 51.0 |
| Rice sugar | 16.0 |
| Garlic paste | 4.0 |

The final composition of the loaf was the following:

| Assembly | g/100 g |
|---|---|
| Extrudate pieces | 51.4 |
| Connective tissue analogue | 20.5 |
| Fat analogue | 2.4 |
| Marinade preparation | 25.7 |

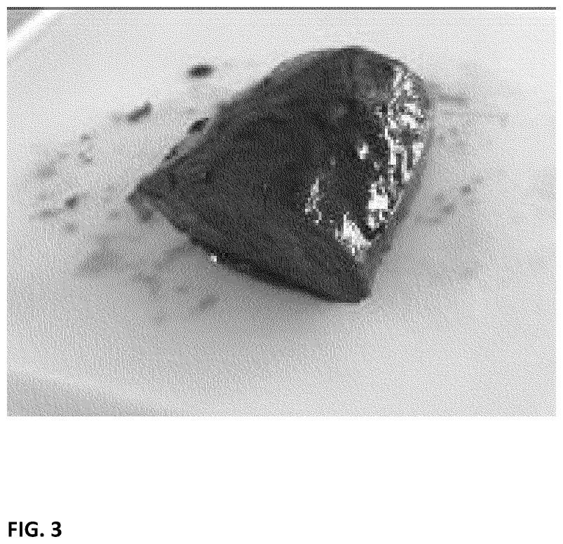

The loaf segment is sealed in a bag filled with marinade (FIG. 3a).

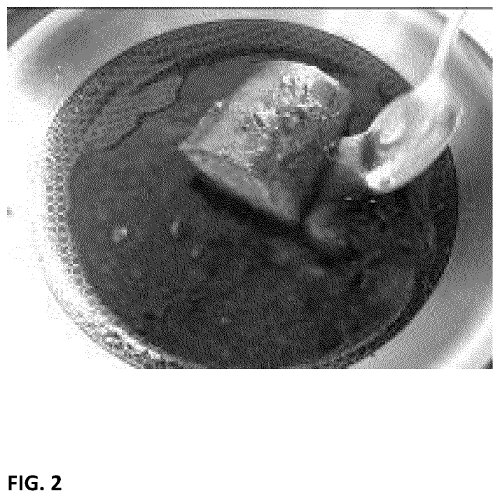

The roast was separated from the marinade. The roast was put in a pan with a tablespoon of sunflower oil. The pan was placed in an oven (photo 2) at 130° C. with fan, level 3 and the thermometer in center of the roast (for about 11 mins). Care was taken that it didn't burn underneath. At 60° C. core temperature, the marinade was added (for about 7 mins). At 70° C., it was taken out of the oven and finished by roast glazing it in the pan on the hob (2 to 3 mins—FIG. 2). It was cut and served after waiting 5 minutes (FIG. 3).

### Example 3

### Ham Analogues

The extrudates were assembled with a connective tissue analogue. The connective tissue analogue was used in between the extrudate pieces to ensure the cohesion and the flavouring of the final steak analogue. The assembled structures were placed in a plastic bag, sealed under vacuum and cooked in a steam oven.

| | g/100 g |
|---|---|
| Wheat gluten | 11.8 |
| Pea protein isolate | 25.8 |
| Insoluble particles | 3.9 |
| Flavors | 3.3 |
| Colors | 2 |
| Preservative | 3.9 |
| Water | 49.2 |

| Connective tissue | |
|---|---|
| analogue recipe | g/100 g |
| Flavors | 7.0 |
| egg | 12.0 |
| Vegetable broth | 2.0 |
| Water | 79.0 |

The loaf composition for the ham is the following:

| | g/100 g |
|---|---|
| Extrudate pieces | 75 |
| Binder | 25 |

One difference with steak is the slicing. Ham slices were cut in the direction of fiber alignment with a thickness from 3 to 6 mm (FIG. 3b).

### Example 4

### Trans Glutaminase Binder

Another example is to use Enzymes to bind the successive layers of extrudates: In this case the recipe are the following:

| Mixture 1 | % | g |
|---|---|---|
| Demi glace maggi | 4 | 40 |
| wurtz | 4 | 40 |
| Base note | 4 | 40 |
| water | 88 | 880 |
| sum | 100 | 1000 |

### Example 5

### Fish Fillet Analogue

Extrudates from high moisture extrusion with fish-like texture are produced and assembled by using a connective tissue analogue to prepare fish analogues including salmon, tuna, white fish in the format of fillet or other products based on fish meat.

The extrudates are by wet extrusion using a twin-screw extruder and a conic short coat hanger cooling die. The extrudate is obtained by extruding a dough made of plant protein isolates or concentrate powders and water. Flavor and color can be added in the extrusion process depending on the application. The moisture of the dough is in between 50 and 65%. The extrusion temperature can vary from 120° C. to 180° C. depending on the extrusion flow-output (kg/h) and on the moisture content. The extrudate can be composed of pieces of a size of approximately 10×6 cm or of continuous slab of a width depending on the size and design of the extrusion die. The texture of extrudates are composed by short or long fibres which mimic the texture of real fish fillet muscle. The extrudates can be used as such, washed and/or flavored depending on the application.

### Salmon Fillet Extrudates

To obtain softer extrudates, lower temperatures as compared to those used for beef analogue are used to mimic softer texture of salmon fillet. Color is added to the initial dough to obtain orange/pink color.

Salmon recipe

| | |
|---|---|
| Wheat gluten | 13.2% |
| Pea protein isolate | 27.8% |
| Flavors | 2% |
| Vinegar (10% acetic acid) | 4% |
| Water | 52.97% |
| Color | 0.030% |

To assemble with connective tissue analogue, the slabs (belt-like) are layered and bound by a connective tissue analogue to produce a block similar to fish fillet (5-10 cm height, more than 5 layers). This connective tissue analogue has a white color similar to fat.

The connective tissue analogue is made of seaweed flour rich in kappa carrageenan, konjac glucomannan, salt, potassium chloride, a starch, a plant protein and plant oil, listed in the table below. Seaweed extract is prepared by boiling seaweed flakes in water for 5 min with following filtration. Seaweed extract is used to boost the fishy flavor and umami taste. Soy protein isolate was dispersed in the seaweed extract after it cools down, and then add oil while mixing. A coarse emulsion is made by applying high shear shortly. Then carrageenan rich seaweed, konjac flour, salts and flavors were fully hydrated in the emulsion and heated at 85° C. for 10 min. The hydrated dough or heated dough (T>70° C.) is applied by brushing, dosing, spraying between the slabs to connect the extrudates. The assembled block with layered structure is tightly packed and heated in oven to re-melt the fat analogue, distribute and bind better the extrudates to form compact texture. After cooling down, fish fillet with layers is completed. While heating, the fat analogue is partially melted, providing the effect of flakiness when cutting by fork. This binder softens while cooking to release oil which improves the creaminess, juiciness, flavor release, and provides flakiness while cutting due to the easy separation of the layered slabs.

| Ingredients | g/100 g |
|---|---|
| Soy protein isolate | 5 |
| Seaweed extract | 73.35 |
| Rapeseed oil | 15 |
| Salt (NaCl) | 2.25 |
| Salt (KCl) | 0.3 |
| Seaweed flour (carrageenan) | 0.8 |
| Konjac flour (glucomannan) | 0.3 |
| Corn starch | 2 |
| Vegan fish flavor | 1 |

### Example 6

### Fish Finger Preparation Method

The binder (e.g. 30%) is heated (above 70° C.) and mixed with high moisture extrudates (e.g. 70%). The mixture is molded in a bag or container with an applied pressure e.g. vacuum sealing which was then heated at 85° C. for 15 min to better distribute the binder and make the compact structure. After cooling down, the solid is cut into slices similar to fish finger, and breaded before frozen. When the breaded vegan fish finger is deep fried, the texture is soft, flaky and creamy due to the partial melting of the fat analogue.

### Example 7

Effect of Die Geometry The effect of different die geometries were tested. Die geometries 0, 1, 2, 2b, 3, 4, 6, and 7 were manufactured having the dimensions of various features as shown in the table below.

| | Exit | | | | | | | |
|---|---|---|---|---|---|---|---|---|
| | slit | Exit | Exit | Exit | | | Specific | |
| | outer | slit | slit | slit | Surface | | surface | |
| Geometry | diameter, | inner | gap | length | area | Volume | area, | |
| name | mm | diameter | mm | mm | mm² | mm² | 1/mm | L/2D |
| 0 | 48.5 | 45.5 | 1.5 | 11.15 | 20125 | 30594 | 0.66 | 0.83691 |
| 1 | 50 | 44 | 3 | NA | 19748 | 29784 | 0.66 | 0.8369 |
| 2 | 48.5 | 45.5 | 1.5 | 21.7 | 19777 | 24668 | 0.80 | 0.7183 |
| 2b | 48.5 | 45.5 | 1.5 | 11.15 | 19777 | 27005 | 0.73 | 0.7183 |
| 3 | 50 | 47 | 1.5 | 14.73 | 21370 | 24149 | 0.88 | 0.81 |
| 4 | 50 | 47 | 1.5 | 14.73 | 21399 | 23565 | 0.91 | 0.81 |
| 6 | 52 | 45 | 3.5 | 24.73 | 21352 | 29880 | 0.71 | 0.81 |
| 7 | 48.5 | 45.5 | 1.5 | 11.15 | 20304 | 29641 | 0.68 | 0.96 |

The cylindrical length and cone length of each die geometry is shown in the table below.

| Geometry | | Cylindrical | Cone |
|---|---|---|---|
| name | Description | length, mm | length, mm |
| 0 | Reference conic die | 17.89 | 36.17 |
| 1 | No expansion zone | 42.5 | 36.17 |
| 2 | No expansion zone with | 18 | 36.17 |
| | reduced expansion zone but | | |
| | narrow gap and longer slit | | |
| | exit length | | |
| 2b | No expansion zone with | 28.55 | 36.17 |
| | reduced expansion zone but | | |
| | narrow gap and shorter slit | | |
| | exit length | | |
| 3 | Multiple expansion zones, | 34.65 | 27.36 |
| | aligned and periodical | | |
| 4 | Multiple expansion zones, | 34.65 | 27.36 |
| | misaligned | | |
| 6 | multiple expansion zones, | 24.65 | 27.36 |
| | periodical and aligned with | | |
| | larger exit slit gap | | |
| 7 | Reference geometry with a | 17.89 | 36.17 |
| | shoulder | | |

A short description and comment on each geometry is provided in the table below

| Geometry | | |
|---|---|---|
| name | Description | Comment |
| 0 | The reference conic coat hanger | This particular geometry with |
| | geometry is made up of a conic entrance | pressure variations profile along |
| | followed a cylindrical section and the | the length of the die associates |
| | coat hanger geometry is characterized | with shear rate and protein |
| | by an expansion chamber (ring or | relaxation create specific flow |
| | annulus zone) just before the circular slit | instability at the exit of the die |
| | exit (1.5 mm) | resulting in a specific fiber |
| | | structure and texture |
| 1 | The cylindrical geometry is made up of a | This geometry results gradual |
| | conic entrance followed a cylindrical | pressure variation without |
| | section and is characterized by no | compression and decompression |
| | expansion zone and no restriction but a | cycles within the die. No flow |
| | continuous gap size (3 mm) right from | instabilities and fiber |
| | the entrance until the exit of the die | disorientation occur. The |
| | | geometry results in larger fiber |
| | | bundles with more gap/voids |
| | | between the bundles. |
| 2 | The cylindrical geometry with a longer | The long circular slit exit resulted |
| | slit exit is made up of a conic entrance | in large pressure drop before the |
| | followed a cylindrical section and it is | exit of the die and the die was |
| | characterized by no expansion zone and | blocked. |
| | but with a restriction having a long | |
| | circular slit at the exit (1.5 mm) | |
| 2b | The cylindrical geometry with a shorter | This geometry results |
| | slit exit is made up of a conic entrance | compression just before the exit |
| | followed a cylindrical section and it is | of the die due to the circular slit. |
| | characterized by no expansion zone and | The flow orientation and fiber |
| | but with a restriction having a short | bundles are modified as |
| | circular slit at the exit (1.5 mm) | compared to the reference |
| | | geometry due the absence of the |
| | | expansion chamber. The |
| | | geometry results more |
| | | discontinuous structure and with |
| | | larger gaps fiber bundles. |
| 3 | The multiple restriction (8) geometry is | This geometry results in |
| | made up of a conic entrance followed a | successive disorientations of |
| | cylindrical section having multiple and | fibers with reduction of flow |
| | successive narrowing and expansion | instability at the die exit. This |
| | zones with a circular narrow (1.5 mm) slit | results in more dense fiber |
| | exit | bundles' thickness. |
| 4 | The multiple misaligned restriction (8) | This geometry results more |
| | geometry is made up of a conic entrance | orientation of the fiber bundle in |
| | followed a cylindrical section having | the direction of the flow because |
| | multiple misaligned and successive | of increase in the overall |
| | narrowing and expansion zones with a | pathlength inside the die. |
| | circular narrow (1.5 mm) slit exit. The | |
| | consequence of the multiple misaligned | |
| | restrictions is increase in the path length | |
| | between the conic entrance and the exit | |
| | of the die | |
| 6 | The multiple restriction (8) geometry is | This geometry results in |
| | made up of a conic entrance followed a | successive disorientations of |
| | cylindrical section having multiple and | fibers with reduction of flow |
| | successive narrowing and expansion | instability at the die exit. This |
| | zones with a circular wider (3.5 mm) slit | results in more dense fiber |
| | exit | bundles' thickness with more |
| | | disruptions between the fiber |
| | | bundles. |
| 7 | The modified reference conic coat | This particular geometry with |
| | hanger geometry is made up of a conic | pressure variations profile along |
| | entrance followed a cylindrical section | the length of the die associates |
| | and the coat hanger geometry is | with shear rate and protein |
| | characterized by an expansion chamber | relaxation create specific flow |
| | (ring or annulus zone) just before the | instability at the exit of the die |
| | circular slit exit(1.5 mm) and a shoulder | resulting in a specific fiber |
| | just after the conical part | structure and texture. The |
| | | shoulder creates additional |
| | | disorientation of fibers resulting in |
| | | lot more disruptions between the |
| | | fiber bundles. |

The following recipe was used for each test die geometry:

Pea recipe

| | |
|---|---|
| Wheat gluten | 12.5% |
| Pea protein isolate | 26.5% |
| Insoluble particles | 2.0% |
| Flavours | 2.0% |
| Vinegar (10% acetic acid) | 4.0% |
| Water | 53.0% |

### Example 8

### Sample Microscopy

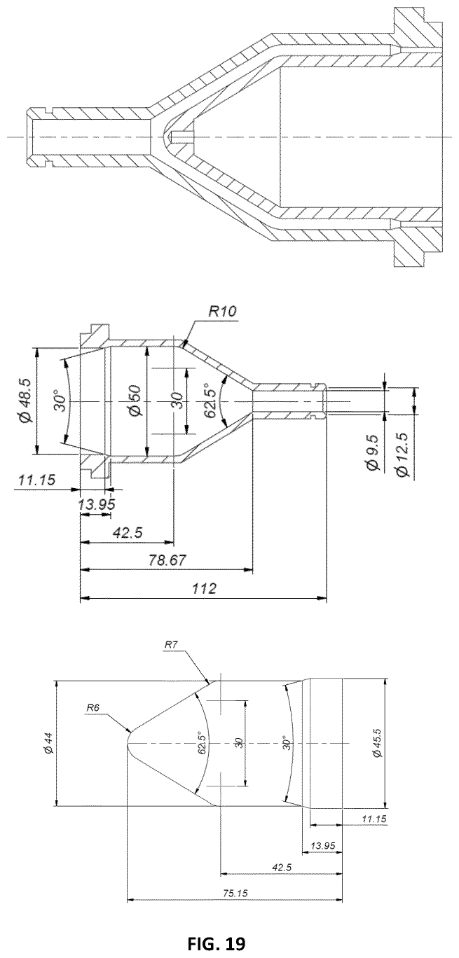

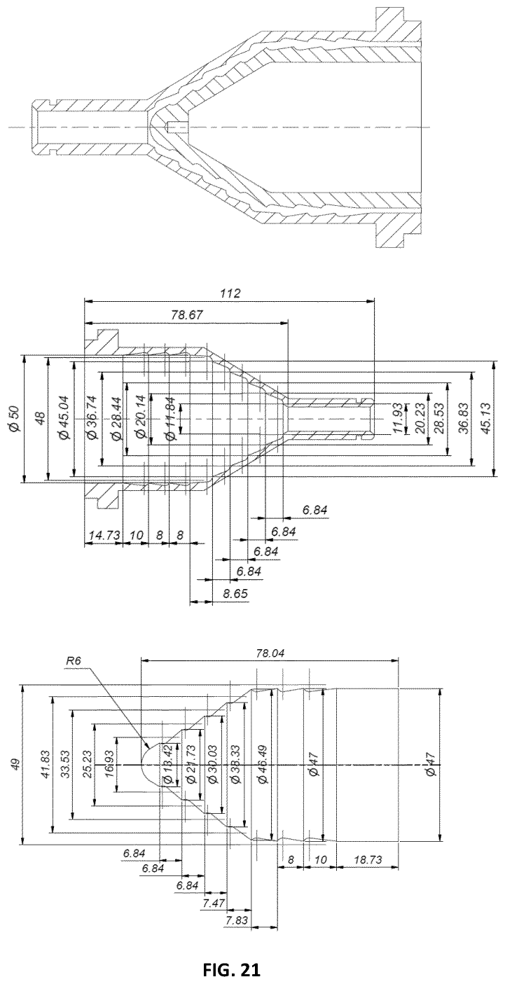

Sample specimens were extracted from extrudates. Specimen dimensions were 18 mm diameter and 3 to 4 mm in height. Specimens were taken from a point of midway between the extrudate edge and its symmetry axis. Sample imaging was performed by X-ray tomography using a pCT 35 from Scanco. The acquisition parameters were as follows: X-ray voltage, 55 kV; Voxel size, 10 μm. The estimate probed volume was the entire specimen. Resulting X-Ray tomographs are shown in FIGS. 22 to 24.

### Feature Thickness Distribution

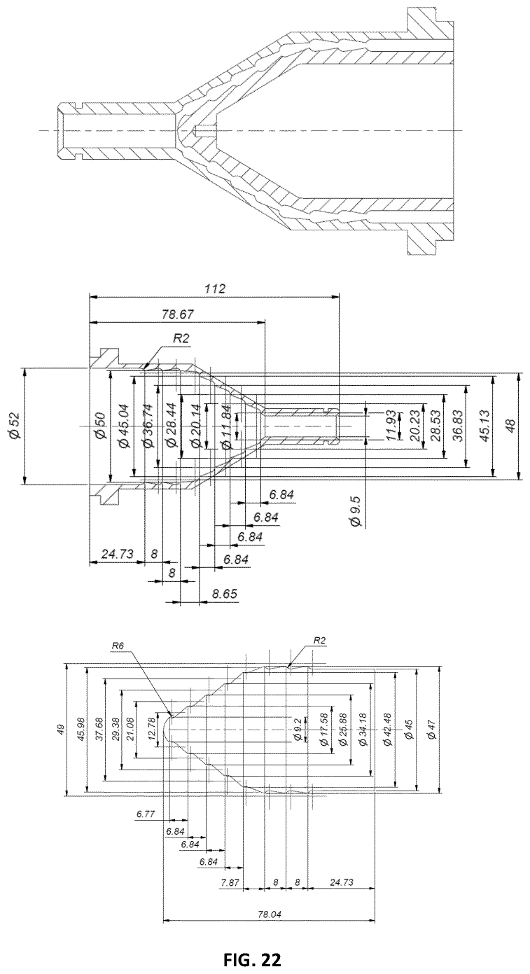

Feature thickness was calculated in 3D. The smallest dimension of each feature independently of the direction. The feature thickness was calculated in the entire tomography volume (see FIG. 25)

| | Geometry | | | | | |
|---|---|---|---|---|---|---|
| | 0 bis | 0 | 1 | 3 | 4 | 6 |
| Mean fiber thickness (μm) | 32 | 34 | 50 | 49 | 53 | 45 |

### Average Feature Number and Feature Thickness in Cross-Section

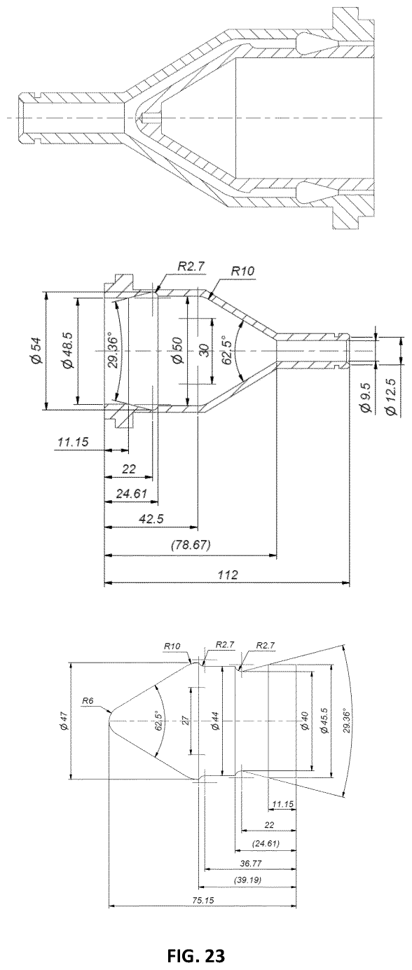

The feature thickness and number were calculated across the specimen section, from id lines in 1000-3000 locations (see FIG. 26).

| | | | | | |
|---|---|---|---|---|---|
| Prior1a | Prior 6 a | Prior 4a | Prior 2a | Prior 3a | Prior 5a |

Average features in cross-section

| | | | | | | |
|---|---|---|---|---|---|---|
| Geometry | 0 bis | 0 | 1 | 3 | 4 | 6 |
| 1 | 37.1 | 33.8 | 22.2 | 17.3 | 22.2 | 25.6 |
| 2 | 36.3 | 32.6 | 26.6 | 19.2 | 21.2 | 28.3 |
| 3 | 34.2 | 37.3 | 25.5 | 16.0 | 19.6 | 23.9 |
| Mean | 35.8 | 34.6 | 24.8 | 17.5 | 21.0 | 25.9 |
| St. Dev | 1.2 | 2.0 | 1.9 | 1.3 | 1.1 | 1.8 |

Average feature thickness

| | | | | | | |
|---|---|---|---|---|---|---|
| 1 | 34 | 39 | 59 | 49 | 51 | 52 |
| 2 | 36 | 40 | 53 | 51 | 44 | 55 |
| 3 | 37 | 42 | 55 | 53 | 51 | 63 |
| Mean | 36 | 40 | 56 | 51 | 49 | 57 |
| St. Dev | 2 | 1 | 2 | 2 | 3 | 4 |

### Orientation Parameters

For Eigenvalue component (x or y or z), 0=all features randomly oriented respect to this axis; 1=all features preferentially oriented towards this axis. For Eigenvalue module, 0=all features randomly oriented; 1=all features showing preferential orientation.

| Geometry | 0 bis | 0 | 1 | 3 | 4 | 6 |
|---|---|---|---|---|---|---|
| Eigenvalue x | 0.24 | 0.26 | 0.21 | 0.31 | 0.23 | 0.06 |
| Eigenvalue y | 0.59 | 0.54 | 0.51 | 0.51 | 0.47 | 0.57 |
| Eigenvalue z | 0.13 | 0.12 | 0.13 | 0.13 | 0.13 | 0.18 |
| Eigenvalue | 0.65 | 0.61 | 0.56 | 0.61 | 0.54 | 0.60 |
| module | | | | | | |

### Shape Parameters

| Geometry | 0 bis | 0 | 1 | 3 | 4 | 6 |
|---|---|---|---|---|---|---|
| Anisotropy | 0.69 | 0.74 | 0.68 | 0.72 | 0.70 | 0.69 |
| Elongation | 0.16 | 0.19 | 0.15 | 0.18 | 0.16 | 0.17 |
| Flatness | 0.01 | 0.09 | 0.03 | 0.06 | 0.03 | 0.14 |

Further explanation with regard to the above values are shown below.

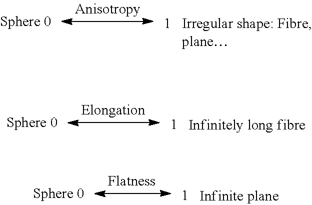

1. A plant based meat or fish analogue product, said product comprising a plant protein based extrudate comprising at least two different plant proteins, wherein said plant protein based extrudate comprises fibres which are aligned in substantially the same direction, wherein the plant protein based extrudate is present as a single extruded slab or as a layer of two or more extruded slabs, and wherein said product is selected from the group consisting of (i) beef; (ii) fish; (iii) pork; (iv) veal; (v) lamb; (vi) cold cut; and (vii) poultry.

2. A plant based meat or fish analogue product according to claim 1 wherein a connective tissue analogue and/or fat analogue is present between the layer of two or more extruded slabs.

3. A plant based meat or fish analogue product according to claim 1 wherein the product comprises (i) between 10 to 40 wt % connective tissue analogue and fat analogue; and (ii) between 60 to 90 wt % extrudate slabs.

4. A plant based meat or fish analogue product according to claim 1, wherein the plant proteins are wheat gluten and pea protein.

5. A plant based meat or fish analogue product according to claim 1, wherein the plant protein based extrudate slabs comprise 5 to 15 wt % wheat gluten and 19 to 29 wt % pea protein.

6. A plant based meat or fish analogue product according to claim 1, wherein the plant protein based extrudate slabs comprise 5 to 15 wt % wheat gluten and 19 to 29 wt % soy protein.

7. A plant based meat or fish analogue product according to claim 1, wherein the single extruded slab or each slab in the layer of two or more extruded slabs has a thickness between 1 to 10 mm.

8. A method of making a plant based extrudate for a meat or fish analogue, said method comprising
a. Feeding an extruder barrel with a composition comprising at least two different plant proteins and water;
b. Extruding the composition at a maximum temperature of between 130 to 190° C.;
c. Cooling the composition through a die; and
d. Cutting the composition to form extrudate slabs.

9. The method according to claim 8, wherein the die is a short die.

10. The method according to claim 8, wherein the extrudate slabs are compressed prior to or during cooking.

11. The method according to claim 8, wherein a connective tissue analogue and fat analogue is applied between the layer of two or more extrudate slabs.

12. The method according to claim 8, wherein flavoring is added with the connective tissue analogue and/or the fat analogue.

13. The method according to claim 8, wherein the layer of two or more extrudate slabs are cooked at a temperature to allow the connective tissue analogue to set and bind the extrudate slabs together.

14. (canceled)
